(19) United States
(12) Patent Application Publication
(10) Pub. No.: US 2006/0004730 A1
(43) Pub. Date: Jan. 5, 2006

(54) Variant standardization engine

(76) Inventor: Ning-Ping Chan, El Cerrito, CA (US)

Correspondence Address: LEON E. JEW, ESQ., Suite 405, 24301 Southland Dr., Hayward, CA, 94545, US

(21) Appl. No.: 11/173,276

(22) Filed: Jul. 1, 2005

Related U.S. Application Data
(60) Provisional application No. 60/585,296, filed on Jul. 2, 2004.

(51) Int. Cl. G06F 17/30

(52) U.S. Cl. 707/3

(57) ABSTRACT

The invention provides a system and method for searching a piece of information from an electronic document, a website or the Internet. The system first standardizes the primary entry entered by the user and then matches the standardized entry to a categorically unique referent in a database, and then identifies the variants of the categorically unique referent and reports all or some of the variants to the search module as search queries.

This application claims priority to the U.S. provisional patent application Ser. No. 60/585,296, filed on 2 Jul. 2004, the contents of which are incorporated by reference herein.

### BACKGROUND OF THE INVENTION

1. Field of the Invention

This invention relates generally to electronic searching technology. More particularly, the invention relates to a system and method for conducting various automatic steps of dialectal/variant standardization in a web-based search engine.

2. Description of Prior Art

The World Wide Web is a fast expanding terrain of information available via the Internet. The sheer volume of documents available on different sites on the World Wide Web (“Web”) warrants that there are efficient search tools for quick search and retrieval of relevant information. In this context, search engines assume great significance because of their utility as search tools that help the users to search and retrieve specific information from the Web by using keywords, phrases or queries.

A whole array of search tools, such as Google, Yahoo, AltaVista, Excite, HotBot, Lycos, Infoseek, Overture, and web Crawler, are available these days for users to choose from in conducting their search. However, search tools are not all the same. They differ from one another primarily in the manner they index information or web sites in their respective databases using a particular algorithm peculiar to that search tool. It is important to know the difference between the various search tools because while each search tool does perform the common task of searching and retrieving information, each one accomplishes the task differently. Hence, the difference in search results from different search engines even though the same phrases/queries are entered.

Search tools of different kinds fall broadly into five categories, i.e. directories, search engines, super engines; meta search engines; and special search engines.

A search engine allows searching of searchable online databases. It has several components: search engine software, spider software, an index (database), and a relevancy algorithm (rules for ranking). The search engine software consists of a server or a collection of servers dedicated to indexing Internet Web pages, storing the results and returning lists of pages to match user queries. The spider software constantly crawls the Web, collecting Web page data for the index. The index is a database for storing the data. The relevancy algorithm determines how to rank queries. A search engine generally includes features such as Boolean operators, search fields, display format, etc.

Search tools like Yahoo, Magellan and Look Smart qualify as web directories. Each of these web directories has developed its own database comprising of selected web sites. Thus, when a user uses a directory like Yahoo to perform a search, he is searching the database maintained by Yahoo and browsing its contents.

Search engines like Infoseek, WebCrawler and Lycos use software programs such as “Web crawlers”, “spiders” or “robots” that crawl around the Web and index, and catalogue the contents from different web sites into the database of the search engine itself. Web crawler programs are a subset of software agents programs with an unusual degree of autonomy which perform tasks for the user. These agents normally start with a historical list of links, such as server lists, and lists of the most popular or best sites, and follow the links on these pages to find more links to add to the database.

A more sophisticated class of search engines includes super engines, which use a similar kind of software as “Web crawlers”, “robots” or “spiders.” However, they are different from ordinary search engines because they index keywords appearing not only on the title but anywhere in the text of site content. Excite, OpenText, Hot Bot and Alta Vista are examples of super engines.

A meta search engine is a search engine that queries other search engines and then combines the results that are received from all. A user using a meta search engine actually browses through a whole set of search engines contained in the database of the meta search engine. Dogpile and Savvy Search are examples of meta search engines.

Special search engines are another type of search engines that cater to the needs of users seeking information on particular subject areas. Deja News and Infospace are examples of special search engines.

Thus, each one of these search tools is unique in terms of the way it performs a search and works towards fulfilling the common goal of making resources on the web available to users. Most search engines allow users to type in a few words, and then search for occurrences of these words in their database. Each one has a special way of deciding what to do about approximate spellings, plural variations, and truncation.

These search engines have a common imperfection, which is the inconsistency among the returned results as responses to various queries which have the same meaning. For example, at Google, the search results of “best cab-driver in New York” and “best taxi-driver in New York” are different. At Yahoo, the search results of “icebox”, “refrigerator”, “fridge” and “Frigidaire” are different. For the same categorical referent, it is imperative to have same search results. Search is about comprehensiveness as well as relevancy. A layman user is entitled to search results that are available to the well educated. There should be a mechanism to avail the search results of “contusion” to laymen searching for the results of “bruise”. The mid-westerners, familiar with terms of bygone era, such as “Frigidaire”, should be able to find, for the same categorical identical referent, relevant search results of “refrigerator”.

Accordingly, it would be desirable to provide a system and method for automatically standardizing the entry.

### SUMMARY OF THE INVENTION

The present invention, defined by the appended claims with the specific embodiments shown in the attached drawings, is directed to a system and method that enables a search engine to return identical search results in responding to various entries which belong to a same categorically unique referent. The system first standardizes the primary entry entered by the user and then matches the standardized entry to a categorically unique referent in a database, and then identifies the variants of the categorically unique referent and reports all or some of the variants to the search module as search queries.

In accordance with this invention, the user's entry for search is automatically pre-treated as one or more queries based on linguistic standardization and/or optimization. The linguistic standardization is based on the concept of a categorically unique referent (CUR). Each categorical word belongs to a CUR. Each CUR may include a number of variants in dialects or in regional variations or social-economic class variations of a same dialect. When the user enters any variant of the CUR, the returned search results will be same. To meet the user's special need, the system allows the user to set language background before conduct a search and allows the user to choose a search mode from full search, optimized search and concise search.

In one preferred embodiment, the invention provides an application that runs in a local computer or a local network. Using this application, the user may conduct a search through the documents stored in the computer or the network.

In another preferred embodiment, the invention provides an application that runs in a website server. Upon entering the website, the user may conduct a search through all pages available in the website.

In another preferred embodiment, the invention provides an application that runs in a web-based search engine's host server. Upon entering the website of the host, the user may conduct a search through all searchable information available on the Internet.

The foregoing has outlined, rather broadly, the more pertinent and important features of the present invention. The detailed description of the invention that follows is offered so that the present contribution to the art can be more fully appreciated.

### BRIEF DESCRIPTION OF THE DRAWINGS

For a more succinct understanding of the nature and objects of the present invention, reference should be directed to the following detailed description taken in connection with the accompanying drawings in which:

FIG. 1 is a schematic diagram illustrating a computer environment wherein the preferred embodiment of this invention operates;

FIG. 2 is a block diagram illustrating the basic steps of the process according to this invention;

FIG. 3 is a schematic block diagram illustrating an application running on a local computer according to one preferred embodiment of this invention;

FIG. 4 is a schematic diagram illustrating the operations of D/V standardization according to FIG. 2 and FIG. 3;

FIG. 5A and FIG. 5B are two schematic flow diagrams illustrating a method according the preferred embodiment of FIG. 3;

FIG. 6 is a schematic diagram illustrating an exemplary utilization of the invention in a website's server;

FIG. 7 is a schematic block diagram illustrating the operations according to FIG. 6;

FIG. 8 is a schematic flow diagram illustrating a method according to the preferred embodiment of FIG. 6 and FIG. 7;

FIG. 9 is a schematic diagram illustrating an exemplary utilization of the invention in a Web-based search engine's host;

FIG. 10 is a schematic block diagram illustrating the operations according to FIG. 9; and

FIG. 11 is a schematic flow diagram illustrating a method according to the preferred embodiment of FIG. 9 and FIG. 10.

### DETAILED DESCRIPTION OF THE INVENTION

With reference to the drawings, the present invention will now be described in detail with regard for the best mode and the preferred embodiments. In its most general form, the invention comprises a program storage medium readable by a computer, tangibly embodying a program of instructions executable by the computer to perform the steps necessary to standardize the search query entered by a user, such that when any variant of the standard search query is entered, an identical search result will be returned.

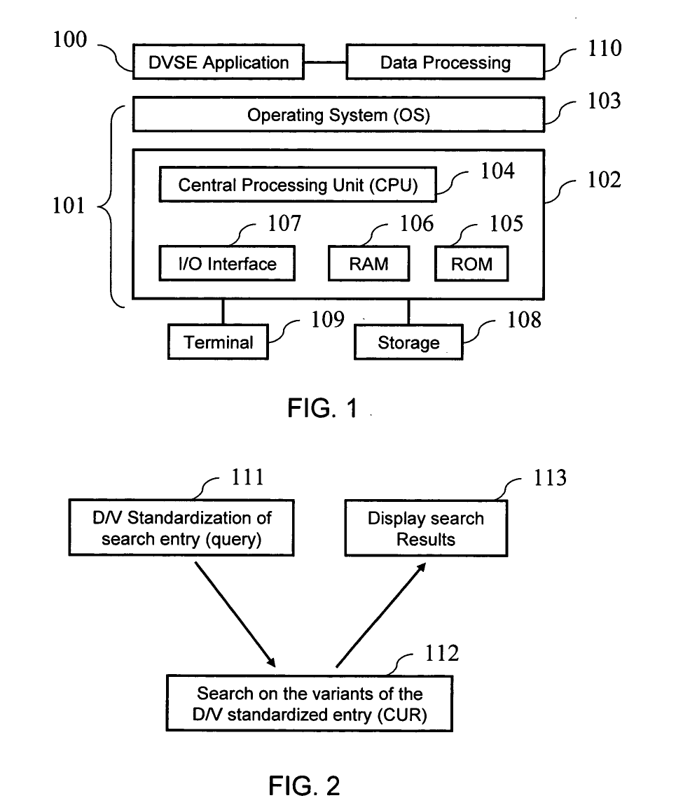

FIG. 1 is a block diagram illustrating the computer environment in which one of the preferred embodiments of this invention operates. The computer environment includes a computer platform 101 which includes a hardware unit 102 and an operating system 103. The hardware unit 102 includes at least one central processing unit (CPU) 104, a read only random access memory (usually called ROM) 105 for storing application programs, a write/read random access memory (usually called RAM) 106 available for the application programs' operations, and an input/output (IO) interface 107. Various peripheral components are connected to the computer platform 101, such as a data storage device 108 and a terminal 109. A search application 100 adapted to a data processing application 110, such as Word, Word Perfect and Microsoft Excel etc., which supports a searchable document, runs on the computer platform 101. Those skilled in the art will readily understand that the invention may be implemented within other systems without fundamental changes.

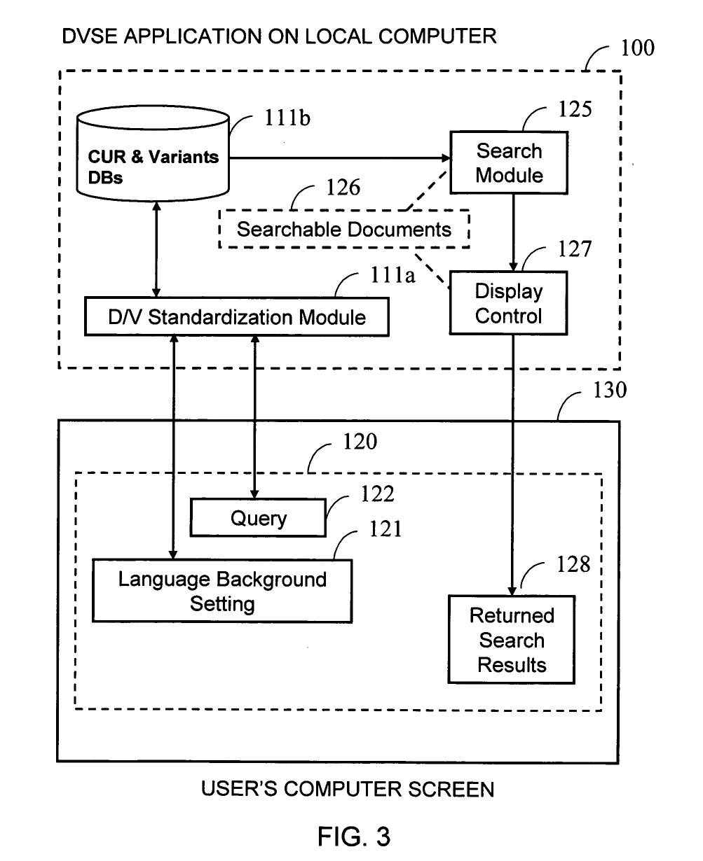

As illustrated in FIG. 2, the system and method according to the present invention, take place in three stages: Dialectal/Variant Standardization 111, search on the variants of the D/V standardized entry 112, and display search results 113.

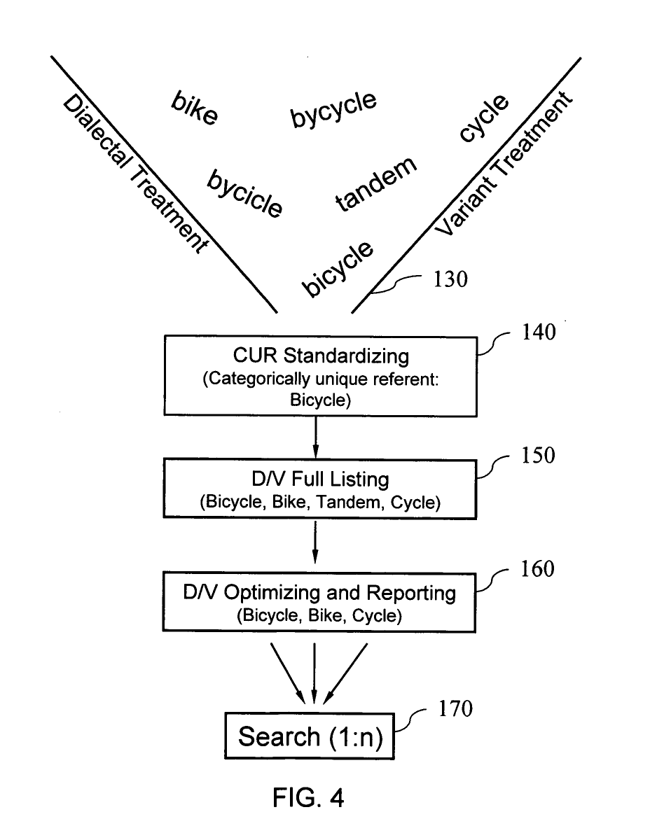

FIG. 3 is a schematic block diagram illustrating one preferred embodiment of the present invention. The Dialectal/Variant Standardization Engine (herein after as DVSE) application 100 is incorporated in a data processing application which supports searchable documents. A user who opens a document 126 may conduct a search via a user graphical interface (GUI) 120 displayed on the user's screen 130. The user uses a language background setting means 121 to set a language background from a number of choices such as current locale, parents' native tongue, schooling dialect, social dialect, most comfortable dialect. The language background setting means 121 can be a dropdown list or a number of hyperlinked icons, each of which represents an option. Typically, the user selects one option. However, the system can be configured to enable the user to choose two or more at the same time. The default language background is preset by the manufacturer but they can be re-set by the user. The default language background can be configured as the language background that the user used last time. In that case, the user does not need to set language background every time when he activates DVSE application. The D/V Standardization Module 111a is a program which is powerful enough to screen, analyze, and transform a non-common use query, such as slang phrase, dialect phrase, teen-language, or specialized terms in medicine, chemistry and botany etc., into a common use query or standardized query. For example, it knows to incorporate auto, automobile, vehicle etc. and standardize the input through statistical abstraction and fuzzy logic. The standardization is based on the conception of “categorically unique referent”. The linguistic studies indicate that each categorical word belongs to a categorically unique referent (CUR) and each CUR has a number of variants. The number of the variants changes from time to time with the evolution of the languages. Among these variants, some are equivalent, but some others may be slightly different in relevancy. After a standardized entry is determined, the D/V Standardization Module 111a looks up to the Database 111b which includes a relevancy algorithm and a number of rules of ranking. Then, the D/V Standardization Module 111a determines scope of variants to be chosen. In the preferred embodiments of this invention, the scope of variants is presented as three basic modes: full search mode, optimized search mode, and precise search mode. In the full search mode, the D/V Standardization Module 111a presents all or substantially all of the identified variants of a CUR to the Search Module 125 which treats each of the variants as a query and performs a search on each of the variants. In the optimized mode, the D/V Standardization Module 111a only presents some of the variants of CUR. These variants are called reportable variants. When the optimized search mode is chosen, the D/V Standardization Module 111a will screen all variants of the CUR and choose some of them based on relevancy or other values associated with a variant. In the precise search mode, the D/V Standardization Module will disable the CUR function and only presents the user's entry to the Search Module 127. If no result is found corresponding to the entry, the system will prompt the user to change the entry.

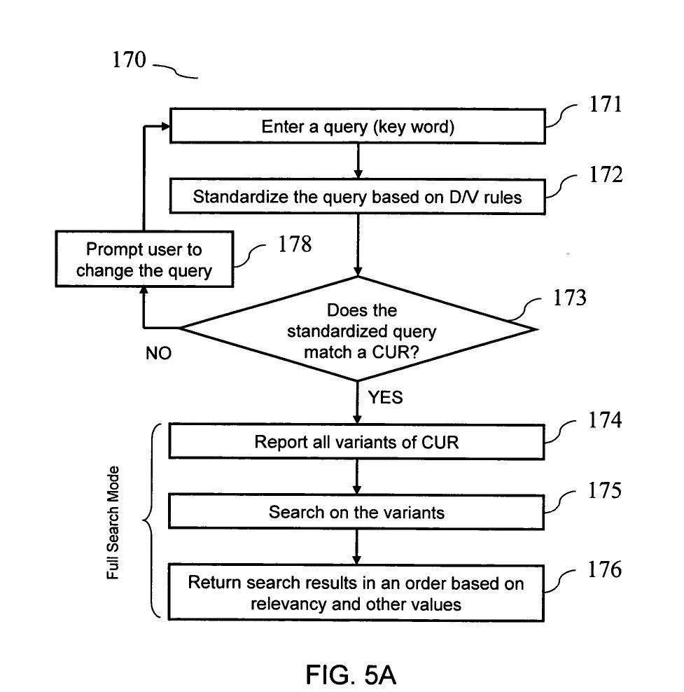

FIG. 4 is a schematic diagram illustrating the operations of D/V Standardization according to FIG. 2 and FIG. 3. In this example, if the user enters any of: bike, cycle, bicycle, tandem, bycicle (misspelled), bicycle (misspelled), the D/V Standardization Module 111a and the Database 111b will first standardize the entry as “bicycle” which represents a CUR. Then, the D/V Standardization Module 111a pulls out the full listings of the variants of CUR “bicycle”. In this example, the full listing of the CUR bicycle's variants include “bicycle”, “cycle”, “bike” and “tandem”. If the full search mode is chosen, the D/V Standardization Module 11a will report all these variants to the Search Module 125. If the optimized search mode is chosen, the D/V Standardization Module 111a will perform an optimization step on the CUR's variants to select some of them based on relevancy and other predetermined rules. In this example, because the “tandem” is much less frequently used in daily life, the D/V Standardization Module 111a only selects and reports “bicycle”, “bike” and “cycle” to the Search Module 125. If the precise search mode is chosen, and if the use enters “tandem”, then the D/V Standardization Module 111a will directly reports “tandem” to the Search Module 125.

The D/V standardization is an essential step because often times words encountered have several different dialectal variations. A language such as English itself is full of dialectal variations in the form of British English, American English, Canadian English, Australian English, Indian English, and African English, etc. Good examples of dialectal variations in British English and American English include centre vs. center, lorry vs. truck, queue vs. line and petrol vs. gasoline etc. Similar instances could be cited in many of the other languages of the world, too. In Chinese, for example there are as many as forty five different dialectal variations for just one particular word. Such instances corroborate the fact that dialectal variations are the rule rather than the exception and therefore the only way to counter them is by standardizing a query or a word to a commonly known word. Even in a same dialect, a CUR may have variants in different semantic regions, such as technical vs. laymen terms, historical vs. current, slang vs. standard, vernacular vs. bookish, regional dialect, personal regional variant due to migration, professional vs. laymen, academic vs. general, Latin origin vs. current usage, brand default generic terms, first maker default generic terms, best maker default generic terms, traditional vs. simplified, acronym vs. full, abbreviations, different version of transliterations, borrowings, etc.

In the preferred embodiments of this invention, if the D/V standardization module fails to recognize the word and thus is unable to perform dialectal/variant standardization, a query prompter unit may prompt the user for more input or request the user to choose from a set of expressions to assist, to clarify and to sharpen his query. In that case the user may submit another query to the query input means. Such a query may either be a standard term or a non-standard term. For example, different variants of the word “auto” including automobile and transportation vehicle are permitted to be input by the user as part of the dialectal/variant standardization process.

The D/V Standardization Module 111a and the Database 111b may be updated from time to time by incorporating the most recent linguistic discoveries and research results such as fuzzy-logic, rules in word formation, laws and pressures from spontaneous innovations, interpretation of statistics, philology, diachronic studies of lexical diffusion, borrowing patterns, genetic relation of language families in different depth of time, etymology, core vocabulary and its manifestation, ease of physical reproduction, and cognitive science-human information processing, etc.

The updating work can be done manually by programmers based on the proposals from the linguists. In this situation, the manufacturers or providers will issue new versions of the application (including the database) to catch up the social and linguistic changes. The updating work can also be done by automatic means. For example, the D/V standardization module and the database are associated with a Web-based electronic survey program. The program collects words, calculates the use frequency and other values of each word, and constantly updates the database. The program also enables experienced dialectologists, at different geographical regions, to monitor and input variants of same referent and keywords into the system where there are principal editors to calculate, evaluate, report of sighting, recording and hearsay of word usage and standardize. The coverage includes technical vs. laymen terms, historical vs. current, slang vs. standard, vernacular vs. bookish, regional dialect, personal regional variant due to migration, professional vs. laymen, academic vs. general, Latin origin vs. current usage, brand default generic terms, first maker default generic terms, best maker default generic terms, traditional vs. simplified, acronym vs. full, abbreviations, different version of transliterations, borrowings, etc.

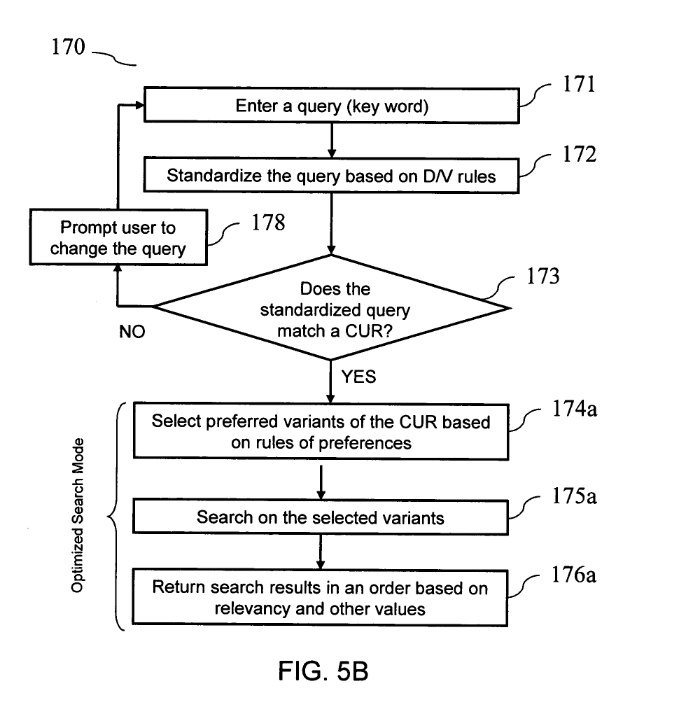

FIG. 5A and FIG. 5 are two schematic flow diagrams illustrating a method 170 according the preferred embodiment of FIG. 3. The method includes the steps of:

Step 171: Enter a query by the user.

Step 172: The system conducts a primary D/V standardization on the query, i.e. standardize the query based on the D/V rules.

Step 173: The system tries to match the standardized query to a categorically unique referent (CUR) stored in the CUR database.

Step 178: If the standardized query fails to match a CUR in the database, the user will be prompt to change the query. A red flag mechanism will be used to alert editor-linguists and/or supervising editor-linguists that there might be a need to create a new CUR, as new words are emerging now and then, here and there, such as blog, bread machine, or new sub-units, such as auto-parts, calling for linguistic community consensus.

Step 174: In a full search mode, if the standardized query does match a CUR in the database, the system lists and reports all the variants associated with the CUR.

Step 175: Search on each of the variants.

Step 176: Return the search results in an order according to relevancy or other values.

Optionally, if an optimized search is set, Step 173 continues on the following steps:

Step 174a: In an optimized search mode, if the standardized query does match a CUR in the database, the system lists and reports one or more variants associated with the CUR based on the rules of preferences.

Step 175a: Search on each of the selected variants;

Step 176a: Return the search results in an order according to relevancy or other rules.

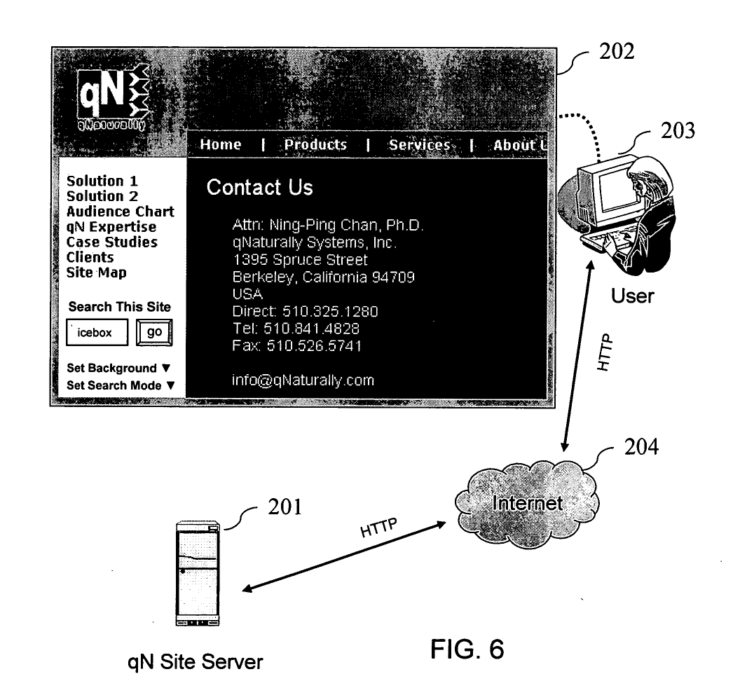

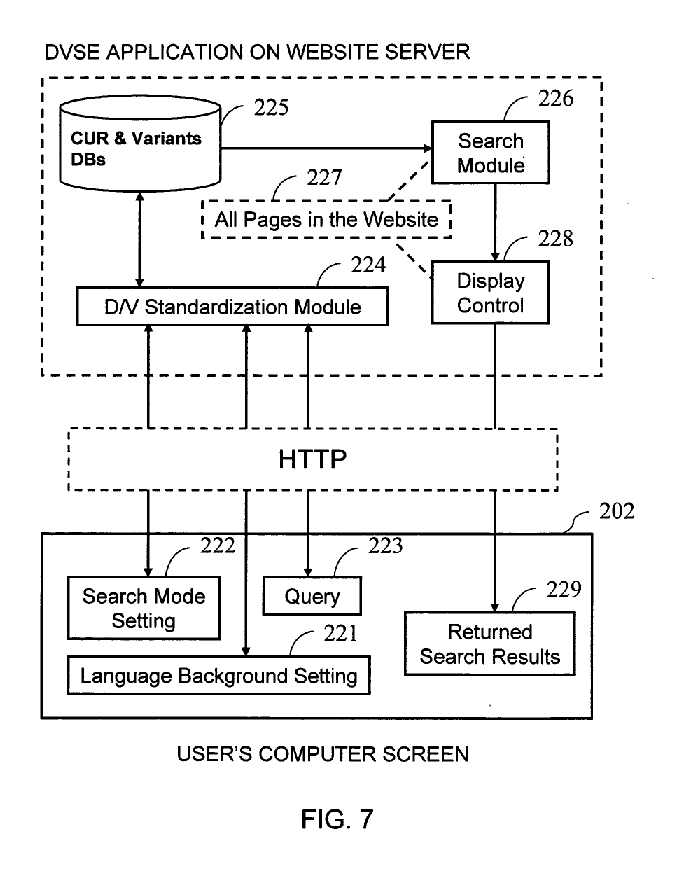

FIG. 6 is a schematic diagram illustrating an exemplary utilization of the invention in a website's server. The application is installed in the website server 201. Upon entering the website's main page, the user may search all pages in the website by entering a keyword via the interface 202. FIG. 7 is a schematic block diagram illustrating the operations according to FIG. 6. Before the user initiates a search, he may set the language background 221 and set the search mode 222 in the user's graphic interface 202. The user enters a keyword as query. When he starts the search by clicking the “GO” button, the query is sent to the D/V Standardization Module 224. The D/V Standardization Module 224 first standardizes the query based on a number of linguistic rules in connection with the selected language background, and then looks up the Database 225 to match the standardized query to a CUR. Then, in accordance with the selected search mode, the D/V Standardization Module 224, together with the Database 225, reports all or some preferred variants of the CUR to the Search Module 226. Then, the Search Module 226 returns the search results 229 to the user via the Display Control 228 and the user's graphic interface 202.

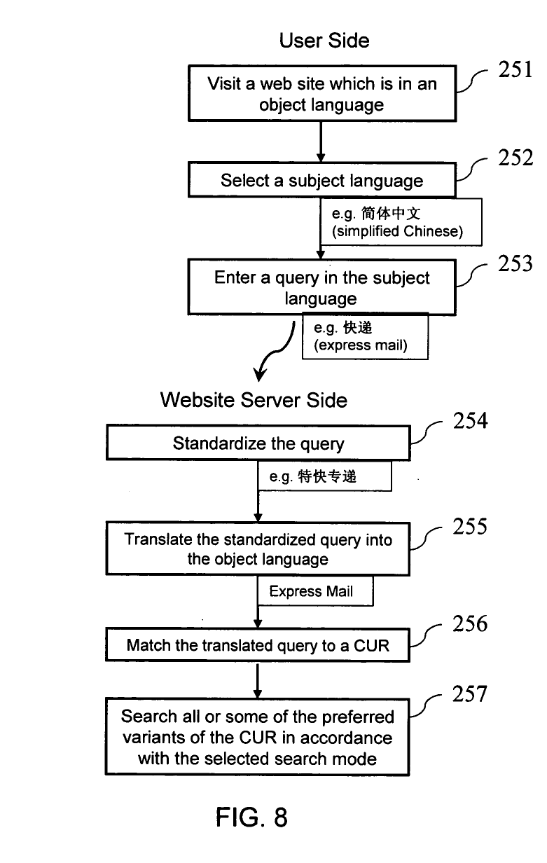

FIG. 8 is a schematic flow diagram illustrating a method according to the preferred embodiment of FIG. 6 and FIG. 7. The method includes the following steps:

Step 251: Access a DVSE enabled website which is in an object language.

Step 252: Select a subject language (which is the user's most comfortable language).

Step 253: Enter a query in the subject language.

Step 254: Standardize the query in the subject language.

Step 255: Translate the standardized query into the object language.

Step 256: Match the translated query to a CUR.

Step 257: Search all or some of the preferred variants of the CUR.

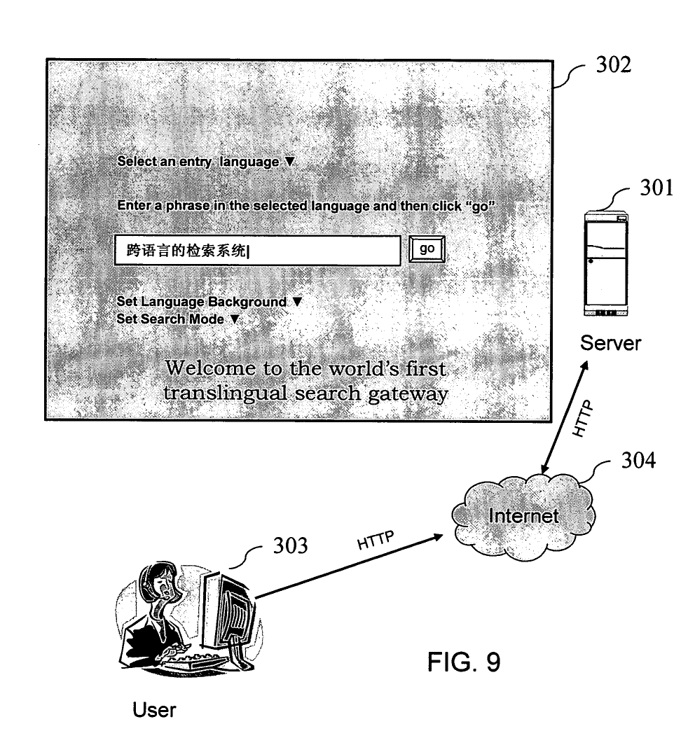

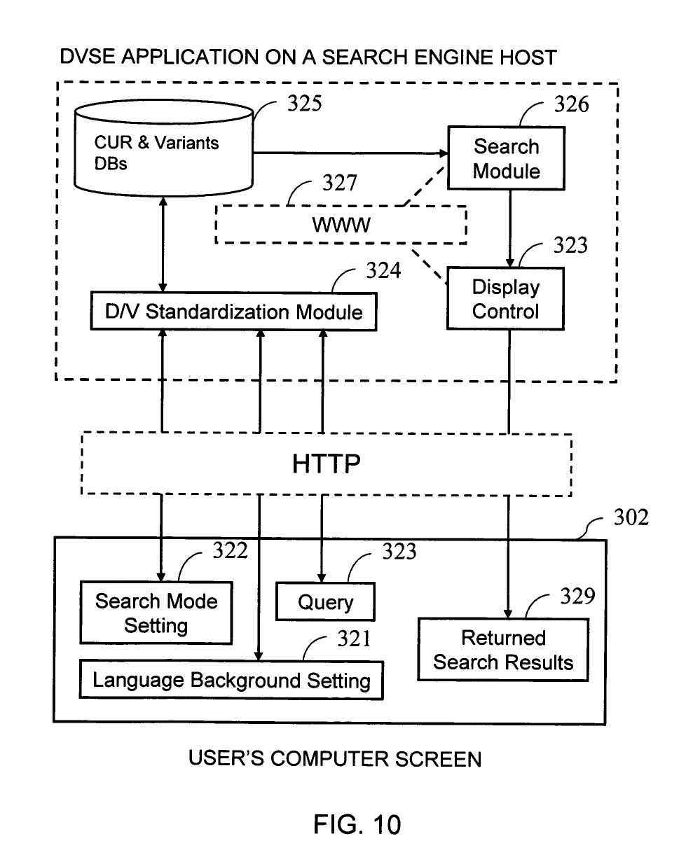

FIG. 9 is a schematic diagram illustrating another exemplary utilization of the invention in a Web-based search engine's host. The application is installed in the website server 301 and runs across the Internet 304. Upon entering the host's main page, the user may search across the Internet by entering a keyword via the interface 302. FIG. 10 is a schematic block diagram illustrating the operations according to FIG. 9. Before the user initiates a search, he may set the language background 321 and set the search mode 322 in the user's graphic interface 302. The user enters a keyword as query. When he starts the search by clicking the “GO” button, the query is sent to the D/V Standardization Module 324. The D/V Standardization Module 324 first standardizes the query based on a number of linguistic rules in connection with the selected language background, and then looks up the Database 325 to match the standardized query to a CUR. Then, in accordance with the selected search mode, the D/V Standardization Module 324, together with the Database 325, reports all or some preferred variants of the CUR to the Search Module 326. Then, the Search Module 326 returns the search results 329 to the user via the Display Control 328 and the user's graphic interface 302.

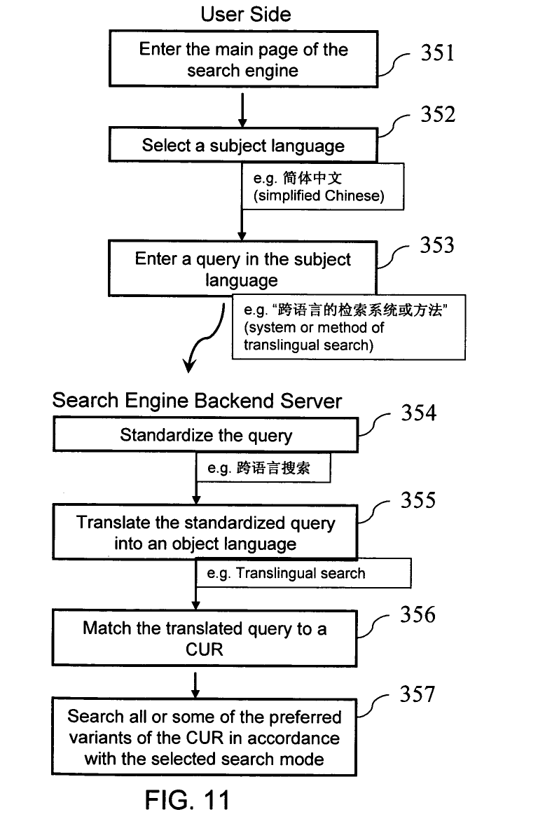

FIG. 11 is a schematic flow diagram illustrating a method according to the preferred embodiment of FIG. 9 and FIG. 10. The method includes the following steps:

Step 351: Access the DVSE's main page which is in an object language.

Step 352: Select a subject language (which is the user's most comfortable language).

Step 353: Enter a query in the subject language.

Step 354: Standardize the query in the subject language.

Step 355: Translate the standardized query into the object language.

Step 356: Match the translated query to a CUR.

Step 357: Search all or some of the preferred variants of the CUR.

Although the invention is described herein with reference to the preferred embodiment, one skilled in the art will readily appreciate that other applications may be substituted for those set forth herein without departing from the spirit and scope of the present invention.

Accordingly, the invention should only be limited by the claims included below.

1. A system for searching information on a computer network comprising a computer communicatively coupled to said network, wherein said computer comprises at least one processor, a first memory that stores at least one program used by said at least one processor to perform operations required for the search and a second memory which is available to said at least one program for operation, the system further comprising:
a means for standardizing a user's entry;
a means for matching the standardized entry to a categorically unique referent which includes one or more variants; and
a means for reporting some or all of the variants of said categorically unique referent to a search means;
wherein said search means executes a search on each of said reported variants and returns the search results to the user.

2. The system of claim 1, further comprising:
a means for setting a search mode from any of:
full search mode;
optimized search mode; and
precise search mode;
wherein when said full search mode is set, said reporting means reports all of the variants of said categorically unique referent to said search means; and
wherein when said optimized search mode is set, said reporting means only reports one or more preferred variants of said categorically unique referent to said search means in accordance with one or more rules for preference; and
wherein when the precise search mode is set, the user's entry is directly reported to said search means.

3. The system of claim 1, further comprising:
a means for setting a language background from a number of options.

4. The system of claim 1, wherein said standardizing means applies a set of statistical, logic, linguistic, and/or grammatical rules to the user's entry.

5. The system of claim 1, further comprising:
a means for prompting the user to enter a different entry in the event that said matching means fails to match said standardized entry to a categorically unique referent.

6. The system of claim 1, wherein said matching means comprises at least one database for storing categorically unique referents and substantially all variants of each of said categorically unique referents, said at least one database being dynamically updated online.

7. In a computer network comprising a server and at least one client computer communicatively coupled to the server, said server comprising a dialectal/variant standardization module, at least one database, a search engine and a display control module, which in combination perform a process, the process comprising the steps of:
standardizing a user's entry;
matching the standardized entry to a categorically unique referent which includes one or more variants; and
reporting one or more of the variants of said categorically unique referent to a search means;
wherein said search means executes a search on each of said reported variants and returns the search results to the user.

8. The method of claim 7, further comprising the step of:
setting a search mode from any of:
full search mode;
optimized search mode; and
precise search mode;
wherein when said full search mode is set, all of the variants of said categorically unique referent are reported to said search means; and
wherein when said optimized search mode is set, only one or more preferred variants of said categorically unique referent are reported to said search means in accordance with one or more rules for preference; and
wherein when the precise search mode is set, the user's entry is directly reported to said search means.

9. The method of claim 7, further comprising the step of:
setting a language background from a number of options.

10. The method of claim 7, wherein the step for standardizing further comprises a sub-step of:
applying a set of statistical, logic, linguistic, and/or grammatical rules to the user's entry.

11. The method of claim 7, further comprising the step of:
prompting the user to enter a different entry in the event that said standardized entry fails to match a categorically unique referent.

12. The method of claim 7, further comprising the step of
dynamically updating online the database containing categorically unique referents and substantially all variants of each of said categorically unique referents.

13. A computer usable medium containing instructions in computer readable form for carrying out a process for searching information in a computer network, said process comprising the steps of:
standardizing a user's entry;
matching the standardized entry to a categorically unique referent which includes one or more variants; and
reporting one or more of the variants of said categorically unique referent to a search means;
wherein said search means executes a search on each of said reported variants and returns the search results to the user.

14. The computer usable medium of claim 13, further comprising the step of:
setting a search mode from any of:
full search mode;
optimized search mode; and
precise search mode;
wherein when said full search mode is set, all of the variants of said categorically unique referent are reported to said search means; and
wherein when said optimized search mode is set, only one or more preferred variants of said categorically unique referent are reported to said search means in accordance with one or more rules for preference; and
wherein when the precise search mode is set, the user's entry is directly reported to said search means.

15. The computer usable medium of claim 13, further comprising the step of:
setting a language background from a number of options.

16. The computer usable medium of claim 13, wherein the step for standardizing further comprises a sub-step of:
applying a set of statistical, logic, linguistic, and/or grammatical rules to the user's entry.

17. The computer usable medium of claim 13, further comprising the step of:
prompting the user to enter a different entry in the event that said standardized entry fails to match a categorically unique referent.

18. The computer usable medium of claim 13, further comprising the step of:
dynamically updating the database containing categorically unique referents and substantially all variants of each of said categorically unique referents.
